(19) United States
(12) Patent Application Publication
(10) Pub. No.: US 2002/0072845 A1
(43) Pub. Date: Jun. 13, 2002

(54) Control device for actuators of an internal combustion engine

(76) Inventors: Volker Eichenseher, Beratzhausen (DE); Thomas Vogt, Regensburg (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 10/033,226

(22) Filed: Oct. 22, 2001

Related U.S. Application Data
(63) Continuation of application No. PCT/DE00/01017, filed on Apr. 3, 2000.

(30) Foreign Application Priority Data
Apr. 21, 1999 (DE) 199 18 031.8

(51) Int. Cl. F02D 41/22

(52) U.S. Cl. 701/107; 701/114

(57) ABSTRACT

A control device includes at least two control units that each generate actuating signals for actuating at least one disjunctive actuator. The control units are connected to one another through monitoring lines. A superordinate control unit controls the other control units and is also connected through monitoring lines to at least one of the at least two control units. The monitoring lines are provided for passing on monitoring signals. Using the monitoring signals, the individual control units monitor the fault-free functioning of another control unit.

### CROSS-REFERENCE TO RELATED APPLICATION

This application is a continuation of copending International Application No. PCT/DE00/01017, filed Apr. 3, 2000, which designated the United States.

### BACKGROUND OF THE INVENTION

### FIELD OF THE INVENTION

The invention relates to a control device for actuators of an internal combustion engine.

European Patent Application 0 493 634 A1, corresponding to U.S. Pat. No. 5,072,700 to Kawamura, discloses a control device for actuators of an internal combustion engine. The actuators are electromagnetic actuators to which charge cycle valves are assigned as final controlling elements. The control device includes a control unit that generates actuating signals for all the actuators and, for that purpose, evaluates sensor signals. It must be possible to generate the actuating signals with a high chronological resolution because it is necessary to use computationally intensive control and regulating algorithms in order to ensure very rapid and precise opening and closing of the charge cycle valves and at the same time ensure low noise emission by the electromagnetic actuator. In addition, the control unit also controls the injection valves that meter fuel. The Kawamura prior art control device has the disadvantage that a single control unit does not make available the necessary computing power to carry out the computationally intensive control and regulating algorithms under the required real-time conditions. It has, therefore, been proposed to provide the control device with a plurality of control units that each generates actuating signals for subsets of the actuators.

The monitoring of the actuators and of the control units is an essential precondition for reliable and low-emission operation of the internal combustion engine.

### SUMMARY OF THE INVENTION

It is accordingly an object of the invention to provide a control device for actuators of an internal combustion engine that overcomes the hereinafore-mentioned disadvantages of the heretofore-known devices of this general type and that is simple and at the same time ensures reliable operation of the internal combustion engine.

With the foregoing and other objects in view, there is provided, in accordance with the invention, a control device for disjunctive actuators of an internal combustion engine including monitoring lines including output monitoring lines and input monitoring lines, resetting lines, at least two control units each generating actuating signals for actuating a respective disjunctive actuator of the internal combustion engine, the at least two control units connected to one another through the monitoring lines and through the resetting lines, at least one monitoring unit, a superordinate control device for controlling the at least two control units, the superordinate control device connected to the at least one monitoring unit through the monitoring lines, each of the at least two control units and the superordinate control device having at least one of the output monitoring lines, at least one of the input monitoring lines, and at least one of the resetting lines, generating a monitoring signal and transmitting the monitoring signal through the at least one of the output monitoring lines, monitoring a fault-free functioning of at least one of the group consisting of the superordinate control device and another one of the at least two control units as a function of the monitoring signal received through the at least one of the input monitoring lines having a resetting signal generator for generating a resetting signal and transmitting the resetting signal through the at least one of the resetting lines, the resetting signal generator generating the resetting signal when a faulty function of at least one of the group consisting of the superordinate control device and another one of the at least two control units, is detected, and a respective one of the superordinate control device and the at least two control units being reset into a predefined initialization state when the resetting signal is received.

The invention is distinguished in that the control units present for controlling actuators monitor one another simultaneously for fault-free functioning. Thus, on one hand, existing computational capacities of the control units are utilized and, on the other hand, a high level of reliability is ensured because the mutual monitoring is carried out in a decentralized fashion.

In accordance with another feature of the invention, the superordinate control device and the control units are connected to one another in the form of a ring through the monitoring lines. The configuration ensures that all the control units are monitored with a very low degree of expenditure on wiring.

In accordance with a further feature of the invention, there is provided at least one signaling line connecting the superordinate control unit to the control units. At least one of the superordinate control device and the control units generate a signaling signal and transmit the signaling signal through the signaling line when a faulty function of the superordinate control device or another one of the control units is detected.

In accordance with an added feature of the invention, the internal combustion engine has cylinders with final controlling elements, the signaling line is a plurality of signaling lines connecting the superordinate control unit to the control units for transmitting signaling signals, and at least one of the superordinate control device and the control units generate actuating signals for controlling actuators for the final controlling elements of only one cylinder of the cylinders and transmit the actuating signals through the signaling lines when a faulty function of the superordinate control device or another one of the at least two control units is detected.

In accordance with an additional feature of the invention, the actuators are electro-mechanical actuators, the internal combustion engine has charge cycle valves, at least a subset of the control units generate actuating signals for controlling the electro-mechanical actuators, and each of the electro-mechanical actuators is assigned one of the charge cycle valves as final controlling element.

In accordance with yet another feature of the invention, there are provided control lines, the internal combustion engine has injection valves each with an output stage, and each of the subset of the control units generating the actuating signals for controlling the electro-mechanical actuators have direct access to the output stage through the control lines.

In accordance with yet a further feature of the invention, the at least one monitoring unit is part of the control units.

With the objects of the invention in view, there is also provided a control device for disjunctive actuators of an internal combustion engine including controllers, monitoring lines, and resetting lines. The monitoring lines include output monitoring lines and input monitoring lines. The controllers include control units and a superordinate control device for controlling the control units. The monitoring lines connect the control units and the control device to one another. The resetting lines are used for transmitting resetting signals and connect the control units and the control device to one another. Each of the control units generates actuating signals for actuating a respective one of the actuators. Each of the controllers generates a monitoring signal and transmits the monitoring signal through at least one of the output monitoring lines, monitors fault-free functioning of another of the controllers as a function of the monitoring signal received through at least one of the input monitoring lines, and have a resetting signal generator transmitting the resetting signal through at least one of the resetting lines when a faulty function of at least one of the controllers is detected. A respective one of the controllers is reset into a predefined initialization state when the resetting signal is received by that controller receiving the resetting signal.

With the objects of the invention in view, there is also provided a control device for disjunctive actuators of an to internal combustion engine including controllers, monitoring lines, and resetting lines. The monitoring lines include output monitoring lines and input monitoring lines. The controllers include control units and a superordinate control device for controlling the control units. The monitoring lines connect the control units and the control device to one another. The resetting lines are used for transmitting resetting signals and connect the control units and the control device to one another. Each of the control units generates actuating signals for actuating a respective one of the actuators.

Each of the controllers has an output monitoring line, an input monitoring line, an output resetting line, and an input resetting line, generates a monitoring signal and transmits the monitoring signal through the output monitoring line, monitors fault-free functioning of another of the controllers as a function of the monitoring signal received through the input monitoring line, and have a resetting signal generator transmitting the resetting signal through the output resetting line when a faulty function of at least one of the controllers is detected. A respective one of the controllers is reset into a predefined initialization state when the resetting signal is received through the input resetting line by that controller receiving the resetting signal.

Other features that are considered as characteristic for the invention are set forth in the appended claims.

Although the invention is illustrated and described herein as embodied in a control device for actuators of an internal combustion engine, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a block circuit diagram of a first embodiment of a control device for actuators of an internal combustion engine according to the invention; and

FIG. 2 is a block circuit diagram of an alternative embodiment of the control device of FIG. 1.

### DESCRIPTION OF THE PREFERRED EMBODIMENTS

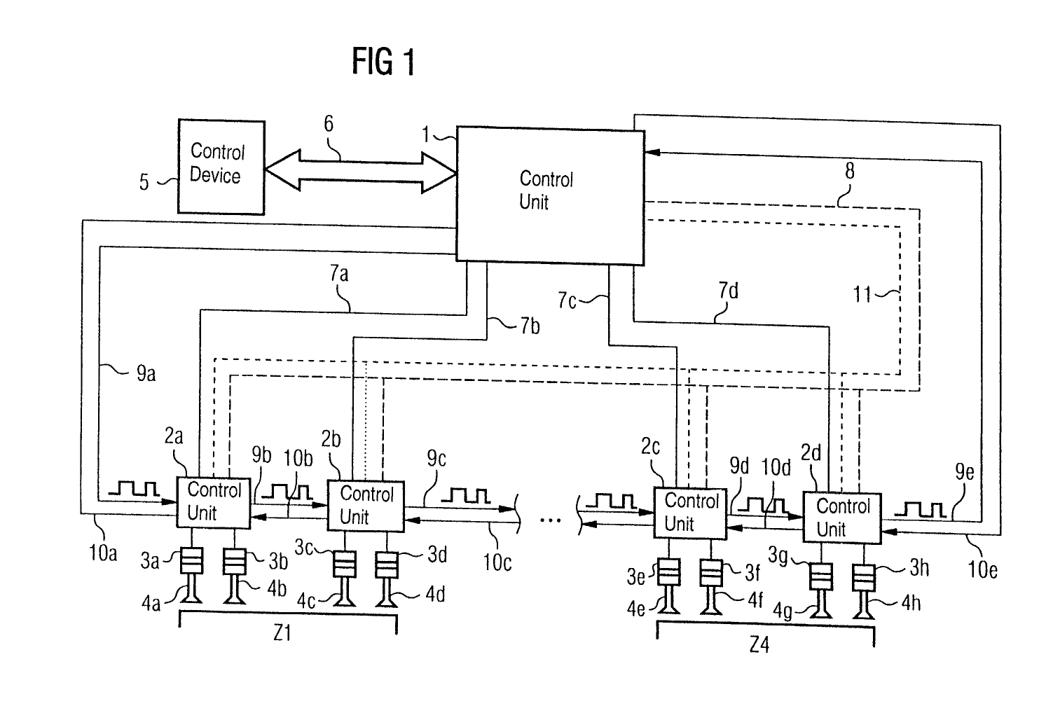

Referring now to the figures of the drawings in detail and first, particularly to FIG. 1 thereof, there is shown a control device including a superordinate control unit 1 and a plurality of control units 2a, 2b, 2c, 2d, which are connected to actuators 3a to h in an electrically conductive fashion. Charge cycle valves 4a to h are assigned, preferably, as final controlling elements, to the actuators. The actuators 3a to h include at least one electromagnet with a coil and a core, and an armature that is coupled to the respective charge cycle valve 4a to h. In addition, the actuators 3a to h includes a restoring device or means that prestresses the armature into a predefined position of rest between a bearing face on the magnet and a further bearing face.

The actuators preferably have two electromagnets. The armature moves, by appropriately actuating the coils of the electromagnets, into a position in which it bears against one of the bearing faces. Thus, the charge cycle valves are actuated.

In each case, four charge cycle valves 4a to d, 4e to h, and, thus, also the actuators 3a to d, 3e to h, are assigned to one cylinder of the internal combustion engine. As such, for example, the actuators 3ato d and charge cycle valves 4a to d are assigned to a first cylinder Z1 of the internal combustion engine, while the actuators 3e to h and charge cycle valves 4e to h are assigned to a fourth cylinder Z4 of the internal combustion engine. In each case, two charge cycle valves 4a , b and 4e, f; 4c, d and 4g, h are respectively disposed on the inlet and outlet sides of the respective cylinder Z1, Z4. The charge cycle valves 4a, b, d, e can, thus, also be referred to as inlet valves, and the charge cycle valves 4c, d and 4g, h can also be referred to as outlet valves. The number of inlet and outlet valves can vary depending on the embodiment of the internal combustion engine.

The control unit 2a is provided for the actuators 3a, 3b for the inlet valves of the first cylinder Z1, while the control unit 2b is provided for the actuators 3c, d for the outlet valves of the first cylinder. The same applies to the control units 2c, d with respect to the fourth cylinder Z4.

An engine control device 5 controls the operation of the internal combustion engine as a function of the rotational speed N of the crankshaft of the internal combustion engine. The rotational speed N is a variable that represents the driver's request, for example, the pedal value of an accelerator pedal sensor, and, if appropriate, further variables, such as, an air mass flow in the intake tract of the internal combustion engine, a temperature of the air sucked in by the internal combustion engine, or an exhaust gas composition sensed by an exhaust gas probe. For such a purpose, the engine control device 5 actuates, for example, injection valves or spark plugs. In addition, the engine control device 5 calculates the desired start of opening of the respective charge cycle valves 4a to h and the desired period of opening in relation to the crankshaft angle.

The engine control device 5 is connected to the superordinate control unit 1 through a first data bus 6. The first data bus 6 is preferably embodied as a Controller Area Network (CAN) bus. The engine control device 5 and the superordinate unit 1 exchange data through the first data bus 6. As such, the superordinate control device 1 receives, from the engine control device 5, the time periods and times of the start of opening of the charge cycle valves 4a to d calculated by the engine control device 5. In addition, the engine control device 5 also respectively transmits the current crankshaft angle of the crankshaft of the internal combustion engine to the superordinate control unit 1. Thus, the superordinate control unit 1 carries out the communication with the engine control device 5. The superordinate control device 1 calculates timing signals for the control units 2a to d as a function of the crankshaft angle and the predefined times of the start of opening and opening periods. As a result, the control units 2a to d are relieved of the tasks of communicating with the engine control device. The computational capacity of the control units 2a to d is, thus, virtually completely available for controlling the actuators 3a to d.

The superordinate control unit 1 is connected to the control units 2a to d through communications lines 7a to d. The superordinate control unit 1 generates timing signals for the respective control units 2a to d. The superordinate control unit 1 transmits the timing signals through the communications lines 7a to d. The timing signals are determined in the superordinate control device 1 as a function of the crankshaft angle, the time of the start of opening of the respective charge cycle valve 4a to h, and the associated opening period. A timing signal is preferably generated for each control unit 2a to d. The timing signal is, for example, a square-wave signal in which the trailing edge indicates the closing of the associated valve and the rising edge indicates the opening of the associated valve. The communications lines 7a to d are preferably configured for unidirectionally transmitting signals from the superordinate control unit to the control units 2a to d.

The control units 2a to d generate actuating signals to move the armature quickly into the respective desired position, that is to say, against the first or second bearing face, so as to ensure that the armature is gently placed in the process. For such a purpose, in each case, a digital processor that executes corresponding control or regulating programs and, in the process, generates the actuating signals for the actuators 3a to d is preferably provided in the control units 2a to d. The position of the armature of the actuators 3a to d is controlled in each case. For regulation, the position is preferably provided as the regulated variable. However, it is also alternatively possible for a variable that is characteristic of the position to be provided as the regulated variable, for example, the current or the flow through one of the coils of the electromagnets of the actuators 3a to d.

The control units 2a to d additionally also monitor the actuators 3a to d. Thus, each of the control units 2a to d can be considered as being a combined device having a control unit and a monitoring unit. Whether or not the armature has undesirably dropped into the position of rest determined by the bias of the restoring device of the actuator is detected, for example, by reference to the sensed position of the armature of the actuator. Also detected is whether or not a fault has, thus, occurred at the actuator. The control units (2a-d) are connected to the superordinate control unit 1 through a second data bus 8. The control units signal the respective state of the actuators 3a to d and a possible failure of one of the actuators to the superordinate control device through the second data bus 8.

The control units 2a to d and the superordinate control unit 1 are connected to monitoring lines 9a to e in a ring-shaped fashion. In addition, the control units 2a to d and the superordinate control unit 1 are also connected to resetting lines 10a to e in a ring-shaped fashion. A signaling line 11 leads from the superordinate control unit 1 to each control unit 2a to d. Each control unit 2a to d and the superordinate control unit 1 generate a monitoring signal that is transmitted through their respective output-end monitoring lines to the respective next control unit or the superordinate control unit 1. Each control unit 2a to d and the superordinate control unit 1 test whether or not the monitoring signal is present at their input-end monitoring lines 9a to e. If one of the control units 2a to d or the superordinate control unit 1 detects that the monitoring signal is not present at its input, it concludes that there is a fault in the control unit or the superordinate control unit 1 that is connected at the output end to the respective monitoring line 9a to e, and brings about a fault reaction.

The resetting lines are preferably configured and constructed such that the data is transmitted through the resetting lines in the opposite direction to the transmission of the monitoring signal in the monitoring lines 9a . For example, the monitoring signal is, therefore, transmitted from the control unit 2a to the control unit 2b. If the control unit 2b detects that the monitoring signal is not transmitted, or is transmitted incorrectly, it preferably causes, as a fault reaction, a resetting signal to be transmitted through the resetting line 10b to the control unit 2a. The resetting line 10b is fed to a resetting input of the control unit 2a. If a resetting signal is present at the resetting input of the control unit 2a, the control unit 2a is reset into a predefined initialization state. To cause the reset, the power supply of the control unit 2a is briefly interrupted, and all the computing programs and electronic elements that may be present, such as a microprocessor or an oscillator, are initialized. The presence of a resetting signal at the respective input of the resetting line 10c, 10d,10e,10a also has the same effect on the other control units 2b, 2c, 2d and the superordinate control unit 1 as on the control unit 2a.

Preferably, the signaling line 11 that connects the superordinate control unit 1 to each of the control units 2a to d is also provided as an alternative to, or in addition to, the resetting lines 10a to e. If one of the control units 2a to d detects a fault of another control unit, that control unit generates a signaling signal that is transmitted to the superordinate control unit 1 through the signaling line 11. Then, the superordinate control unit 1 can interrogate, through the second data bus 8, which of the control units 2a to d is in a fault state, and then cause the corresponding control unit to be reset. Alternatively, if a signaling signal is present on the signaling line 11, it can also reset all of the control units 2a to d or a subset thereof.

The provision of the resetting lines 10a to e has the advantage that when a fault of a control unit is detected, the control unit that has detected the fault can directly carry out the fault reaction so that it affects the faulty control unit. The fault detection and fault reaction, therefore, take place in a decentralized fashion. As a result of the provision of the signaling line and the transmission of corresponding signaling signals, in the event of a fault, it is possible for the superordinate control unit to carry out corresponding fault reactions and, for example, deactivate or reset a group of control units in a selective fashion. The monitoring signal is preferably a square-wave signal with a predefined frequency. Such a square-wave signal can be generated and also evaluated with little computational effort.

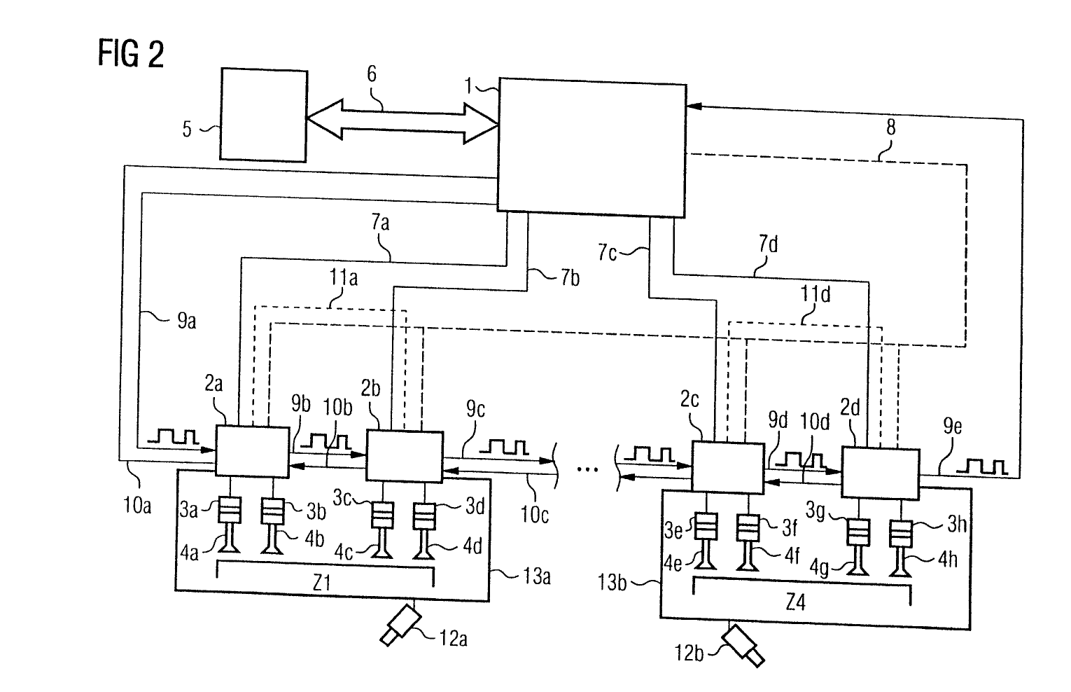

A second embodiment of the control device is described below. Features having an identical construction or function are provided with the same reference symbols as in FIG. 2, and also are not described again in the text that follows.

In contrast to the first embodiment, in the control device according to FIG. 2, all the control units are connected respectively to signaling lines 11a, 11b that generate actuation signals for actuators of precisely one cylinder Z1, Z4. As such, as soon as one of the control units has detected a fault of another control unit that generates actuating signals for actuators of the same cylinder, the fault can be signaled back to all the other control units that also generate actuating signals for actuators of the same cylinder. Based on the signaling signal it is possible to initiate a corresponding emergency operating mode by the respective control units on a decentralized basis, that is to say, for example, the actuation of the actuators can be suspended.

In addition, the control units 2a, 2b, which each generate actuating signals for the actuators of the first cylinder Z1, are directly connected through a control line 13a to the output stage of an injection valve 12a that meters fuel into the first cylinder. As such, when a fault of the control unit 2a is detected, it is possible, for example, for the control unit 2b to transmit a corresponding signal through the control line 13a, which signal causes the metering of fuel by the injection valve 12a to be interrupted, thus, preventing non-combusted fuel from getting into the intake tract of the internal combustion engine. The direct intervention in an output stage of the injection valve 12a has the advantage that, when a fault is detected, the metering of fuel by the injection valve can be interrupted immediately, and not only after a delay due to the transmission of a corresponding fault message to the engine control device 5 through the first and second data buses 6, 8.

The control units 2c, d are also connected through a control line 13b to the output stage of an injection valve 12b that meters the fuel into the fourth cylinder Z4.

Alternatively, it is, for example, also possible for the control unit that is connected to the control unit 2b through the monitoring line 9c to be connected to the injection valve 12a through the control line 13a.

The number of control units 2a to d can vary depending on the embodiment of the invention. In particular, a control unit can also actuate a different number of actuators from that given in the exemplary embodiment. In addition, it is also possible for a subset of the control units also to actuate, inter alia, actuators for the final controlling elements, for example, a spark plug or an injection valve.

In addition to the one superordinate control unit 1, it is also possible to provide at least one further superordinate control unit, for example, a separate non-illustrated superordinate control unit can be provided for all the inlet valves, as well as for all the outlet valves of the internal combustion engine. As a result of such a configuration, a certain degree of redundancy is obtained because, in the event of a failure of a superordinate control unit, another one can take over the functions of that failed unit.

The ring-shaped connection of the superordinate control unit and of the control units 2a to d through the monitoring lines is distinguished by the need for a small number of inputs and outputs on the control units and on the superordinate control unit, and by a low degree of expenditure on wiring. However, any other desired type of wiring of the monitoring lines is also conceivable.

We claim:

1. A control device for disjunctive actuators of an internal combustion engine, comprising:
monitoring lines including output monitoring lines and input monitoring lines;
resetting lines;
at least two control units each generating actuating signals for actuating a respective disjunctive actuator of the internal combustion engine;
said at least two control units connected to one another through said monitoring lines and through said resetting lines;
at least one monitoring unit;
a superordinate control device for controlling said at least two control units, said superordinate control device connected to said at least one monitoring unit through said monitoring lines;
each of said at least two control units and said superordinate control device:
having at least one of said output monitoring lines, at least one of said input monitoring lines, and at least one of said resetting lines;
generating a monitoring signal and transmitting said monitoring signal through said at least one of said output monitoring lines;
monitoring a fault-free functioning of at least one of the group consisting of:
said superordinate control device; and
another one of said at least two control units,
as a function of said monitoring signal received through said at least one of said input monitoring lines;
having a resetting signal generator for generating a resetting signal and transmitting said resetting signal through said at least one of said resetting lines;
said resetting signal generator generating said resetting signal when a faulty function of at least one of the group consisting of:
said superordinate control device; and
another one of said at least two control units, is detected; and
a respective one of said superordinate control device and said at least two control units being reset into a predefined initialization state when said resetting signal is received.

2. The control device according to claim 1, wherein said superordinate control device and said at least two control units are connected to one another in the form of a ring through said monitoring lines.

3. The control device according to claim 1, including at least one signaling line connecting said superordinate control unit to said at least two control units, at least one of said superordinate control device and said at least two control units generating a signaling signal and transmitting said signaling signal through said at least one signaling line when a faulty function of at least one of the group consisting of:
said superordinate control device; and
another one of said at least two control units, is detected.

4. The control device according to claim 2, including at least one signaling line connecting said superordinate control unit to said at least two control units, at least one of said superordinate control device and said at least two control units generating a signaling signal and transmitting said signaling signal through said at least one signaling line when a faulty function of at least one of the group consisting of:
said superordinate control device; and
another one of said at least two control units, is detected.

5. The control device according to claim 4, wherein:
the internal combustion engine has cylinders with final controlling elements;
said at least one signaling line is a plurality of signaling lines connecting said superordinate control unit to said at least two control units for transmitting signaling signals; and
at least one of said superordinate control device and said at least two control units generate actuating signals for controlling actuators for the final controlling elements of only one cylinder of the cylinders and transmit said actuating signals through said signaling lines when a faulty function of at least one of the group consisting of:
said superordinate control device; and
another one of said at least two control units, is detected.

6. The control device according to claim 1, wherein
the actuators are electro-mechanical actuators;
the internal combustion engine has charge cycle valves;
at least a subset of said at least two control units generate actuating signals for controlling the electro-mechanical actuators; and
each of the electro-mechanical actuators is assigned one of the charge cycle valves as final controlling element.

7. The control device according to claim 6, including control lines, the internal combustion engine having injection valves each with an output stage, each of said subset of said at least two control units generating said actuating signals for controlling the electro-mechanical actuators having direct access to said output stage through said control lines.

8. The control device according to claim 1, wherein said at least one monitoring unit is part of said at least two control units.

9. A control device for disjunctive actuators of an internal combustion engine, comprising:
controllers including control units and a superordinate control device for controlling said control units;
monitoring lines connecting said control units and said control device to one another, said monitoring lines including output monitoring lines and input monitoring lines;
resetting lines for transmitting resetting signals, said resetting lines connecting said control units and said control device to one another;
each of said control units generating actuating signals for actuating a respective one of the actuators of the internal combustion engine;
each of said controllers:
generating a monitoring signal and transmitting said monitoring signal through at least one of said output monitoring lines;
monitoring fault-free functioning of another of said controllers as a function of said monitoring signal received through at least one of said input monitoring lines; and
having a resetting signal generator transmitting said resetting signal through at least one of said resetting lines when a faulty function of at least one of said controllers is detected; and
a respective one of said controllers being reset into a predefined initialization state when said resetting signal is received by said respective one of said controllers.

10. A control device for disjunctive actuators of an internal combustion engine, comprising:
controllers including control units and a superordinate control device for controlling said control units;
monitoring lines connecting said control units and said control device to one another, said monitoring lines including output monitoring lines and input monitoring lines;
resetting lines for transmitting resetting signals, said resetting lines connecting said control units and said control device to one another;
each of said control units generating actuating signals for actuating a respective one of the actuators of the internal combustion engine;
each of said controllers:
having an output monitoring line, an input monitoring line, an output resetting line, and an input resetting line;
generating a monitoring signal and transmitting said monitoring signal through said output monitoring line;
monitoring fault-free functioning of another of said controllers as a function of said monitoring signal received through said input monitoring line; and
having a resetting signal generator transmitting said resetting signal through said output resetting line when a faulty function of at least one of said controllers is detected; and
a respective one of said controllers being reset into a predefined initialization state when said resetting signal is received through said input resetting line by said respective one of said controllers.
